(19) United States
(12) Patent Application Publication
(10) Pub. No.: US 2006/0015905 A1
(43) Pub. Date: Jan. 19, 2006

(54) Wireless communication system having program upgrade function and method thereof

(76) Inventor: Bong-geun Lee, Suwon-si (KR)

Correspondence Address: STANZIONE & KIM, LLP, 919 18TH STREET, N.W., SUITE 440, WASHINGTON, DC, 20006, US

(21) Appl. No.: 11/047,590

(22) Filed: Feb. 2, 2005

(30) Foreign Application Priority Data
Jul. 13, 2004 (KR) 2004-54439

(51) Int. Cl. H04N 5/445; H04N 7/16

(52) U.S. Cl. 725/50; 725/39; 725/140

(57) ABSTRACT

A wireless communication system having a program upgrade function and a method thereof. The wireless communication system includes a transmitter to download a common upgrade program and a transmitter side upgrade program from a memory card which stores the common upgrade program, the transmitter side upgrade program and a receiver side upgrade program, and to transmit the common upgrade program and the receiver side program over a wireless channel, and a receiver to receive and store the common upgrade program and the receiver side upgrade program that are transmitted over the wireless channel. The transmitter and receiver can upgrade programs by employing only one memory card and a wireless channel.

### CROSS-REFERENCE TO RELATED APPLICATIONS

This application claims benefit under 35 U.S.C. § 119 from Korean Patent Application No. 2004-54439 filed on Jul. 13, 2004 with the Korean Intellectual Property Office, the entire content of which is incorporated herein by reference.

### BACKGROUND OF THE INVENTION

1. Field of the Invention

The present general inventive concept relates to a wireless communication system having a program upgrade function and a method thereof. More specifically, the present general inventive concept relates to a wireless communication system capable of upgrading programs on a transmitter and a receiver by using a memory card and a wireless channel, and a method of upgrading the programs.

2. Description of the Related Art

A wireless communication system is a system to transmit additional information about data, and audio and video signals through a wireless channel, and includes a transmitter and a receiver. The transmitter transmits the audio and video signals to the receiver through the wireless channel, and the receiver processes the transmitted audio and video signals to be displayed.

The transmitter transmits the additional information about data to the receiver over the wireless channel, and receives from the receiver an ACK signal in correspondence to the transmitted additional information.

The transmitter and the receiver store programs that perform specific communication operations. For example, the transmitter and the receiver respectively have a booting program, and a data transmission program or a data receiving program.

Usually a memory card is used to upgrade the programs stored in the transmitter and the receiver. That is, if a user wants to upgrade the programs stored in the transmitter, the user needs to use a transmitter memory card where the data transmission program is stored. In like manner, if the user wants to upgrade the data receiving program stored in the receiver, the user needs to use a receiver memory card where the data receiving program is stored.

Therefore, in a conventional wireless communication system, if the user wants to upgrade the data transmission and data receiving programs on the transmitter and the receiver of the wireless communication system, the user had to upgrade the data transmission and data receiving programs on the transmitter and the receiver separately. Since the transmitter memory card and the receiver memory card used in the conventional wireless communication system are separately manufactured, a manufacturing cost of the memory card increases.

### SUMMARY OF THE INVENTION

The present general inventive concept provides a wireless communication system having a program upgrade function, capable of upgrading programs of a transmitter and a receiver without considerable difficulty by employing one single memory card and a wireless channel, and a method thereof.

Additional aspects and advantages of the present general inventive concept will be set forth in part in the description which follows and, in part, will be obvious from the description, or may be learned by practice of the general inventive concept.

The above and/or other aspects and advantages of the present general inventive concept may be achieved by providing a wireless communication system having a program upgrade function, the system including a transmitter to download a common upgrade program and a transmitter side upgrade program from a memory card that stores the common upgrade program, the transmitter side upgrade program and a receiver side upgrade program, and to transmit the common upgrade program and the receiver side upgrade program over a wireless channel, and a receiver to receive and store the common upgrade program and the receiver side upgrade program that are transmitted over the wireless channel.

The transmitter may include an interface where the memory card may be mounted, a first storage to store a predetermined common program and a predetermined transmitter side program that are pre-stored in the first storage, a first wireless communication unit to transmit the common upgrade program and the receiver side upgrade program over the wireless channel, and a first central processing unit (CPU) to download the common upgrade program and the transmitter side upgrade program from the memory card onto the first storage to upgrade the predetermined common program and the predetermined transmitter side program when the memory card is mounted on the interface, and to control the first wireless communication unit to transmit the common upgrade program and the receiver side upgrade program stored in the memory card.

If the common upgrade program and the transmitter side upgrade program stored in the memory card are later versions than the predetermined common program and the predetermined transmitter side program that are pre-stored in the first storage, the first CPU upgrades the predetermined common program and the predetermined transmitter side program.

The receiver may include a second wireless communication unit to receive the common upgrade program and the receiver side upgrade program over the wireless channel, a second storage to store the predetermined common program and a predetermined receiver side program that are pre-stored in the second storage, and a second CPU to download the common upgrade program and the receiver side upgrade program that are received through the second wireless communication unit onto the second storage, and to upgrade the predetermined common program and the predetermined receiver side program.

The transmitter may be a set-top box to receive and process audio and video signals from an image source, and the receiver may be a television (TV) to reproduce the audio and video signals received from the transmitter.

Alternatively, the transmitter may be the TV to reproduce the audio and video signals received from the receiver, and the receiver may be the set-top box to receiver and process the audio and video signals from the image source.

The foregoing and/or other aspects and advantages of the present general inventive concept are also achieved by providing a method of upgrading programs in a wireless communication system, the method including downloading a common upgrade program and a transmitter side upgrade program from a memory card that stores the common upgrade program, the transmitter side upgrade program and a receiver side upgrade program, transmitting the common upgrade program and the receiver side upgrade program over a wireless channel, and receiving and storing the common upgrade program and the receiver side upgrade program that are transmitted over the wireless channel.

The transmitting of the common upgrade program and the receiver side upgrade program may include mounting the memory card, downloading the common upgrade program and the transmitter side upgrade program from the memory card, upgrading a predetermined common program and a predetermined transmitter side program that are pre-stored, and transmitting the common upgrade program and the receiver side upgrade program stored in the memory card to a receiver over the wireless channel.

The receiving of the common upgrade program and the receiver side upgrade program may include receiving the common upgrade program and the receiver side upgrade program that are transmitted over the wireless channel, and upgrading the predetermined common program and a predetermined receiver side program that are pre-stored with the received common upgrade program and the received receiver side upgrade program.

The transmitting of the common upgrade program and the receiver side upgrade program may be executed in a set-top box to receive and process audio and video signals from an image source, and the receiving of the common upgrade program and the receiver side upgrade program may be executed in a TV to reproduce the audio and video signals received from a transmitter.

Alternatively, the transmitting of the common upgrade program and the receiver side upgrade program may be executed in the TV to reproduce the audio and video signals received from the receiver, and the receiving of the common upgrade program and the receiver side upgrade program may be executed in the set-top box to receive and process the audio and video signals from the image source and to output the image and audio signals to the TV.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a wireless communication system having a program upgrade function according to an embodiment of the present general inventive concept;

FIG. 2 illustrates a common upgrade program, a transmitter side upgrade program and a receiver side upgrade program stored in a memory card of FIG. 1;

FIG. 3 is a flowchart of a method of upgrading programs in the wireless communication system of FIG. 1; and

FIG. 4 is a schematic block diagram of a wireless communication system having a program upgrade function according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

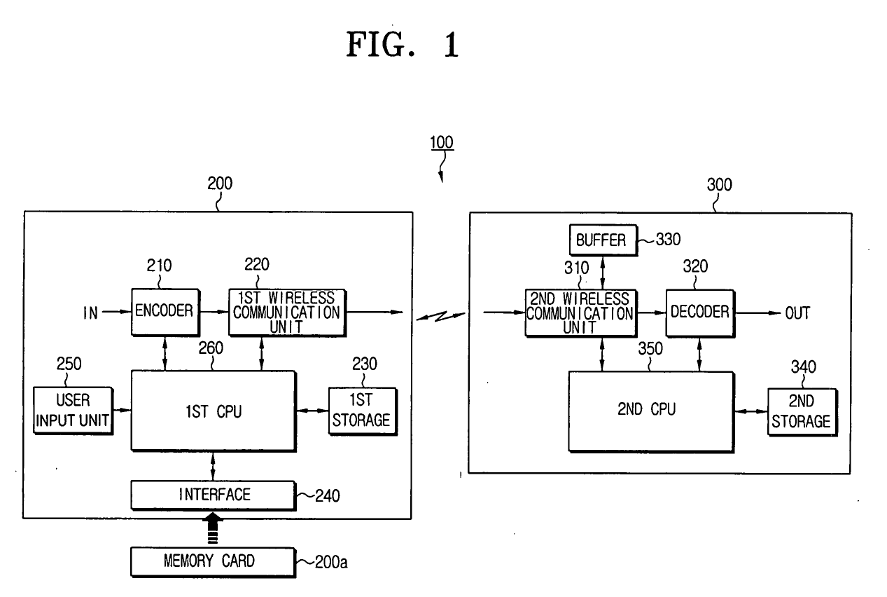

FIG. 1 is a schematic block diagram of a wireless communication system 100 having a program upgrade function according to an embodiment of the present general inventive concept.

Referring to FIG. 1, the wireless communication system 100 includes a transmitter 200 and a receiver 300. The wireless communication system 100 transmits audio and video signals and additional information about data to a digital television (TV) over a wireless channel. The audio and video signals are transmitted uni-directionally while the additional information about data is transmitted bi-directionally.

The transmitter 200 may be a set-top box that encodes the audio and video signals input from an image source, and transmits the audio and video signals to the receiver 300. The receiver 300 may be the digital TV that reproduces the audio and video signals transmitted from the transmitter 200.

As shown in FIG. 1, the transmitter 200 includes an encoder 210, a first wireless communication unit 220, a first storage 230, an interface 240, a user input unit 250, and a first central processing unit (CPU) 260.

The encoder 210 encodes (or compresses) the input audio and video signals in an MPEG (Motion Pictures Experts Group) format. The audio and video signals are input from the image source, for example, a DVD player, a satellite, or a broadcasting station.

The first wireless communication unit 220 transmits the encoded audio and video signals input from the encoder 210, a common upgrade program and a receiver side upgrade program stored in a memory card 200a to the receiver 300 over the wireless channel.

The first storage 230 stores a transmitter control program to control and manage the overall operation of the transmitter 200, a transmitter boot program to boot the transmitter 200, and a transmitter side program to execute diverse functions of the transmitter 200. The transmitter side program is a predetermined transmitter application program. The boot program and the transmitter side program are pre-stored in the first storage 230 and may be upgraded to new versions.

The interface 240 is mounted with the memory card 200a and connects the memory card 200a and the first CPU 260.

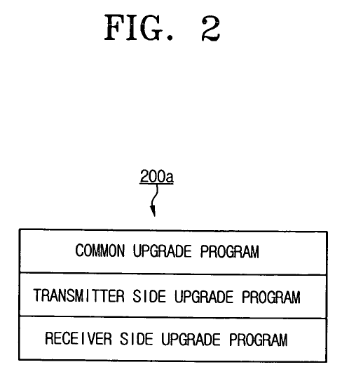

FIG. 2 illustrates the common upgrade program, the transmitter side upgrade program and the receiver side upgrade program stored in the memory card of FIG. 1. The memory card 200a, as shown in FIG. 2, is a storage medium that stores the common upgrade program, the transmitter side upgrade program, and the receiver side upgrade program. The memory card 200a may be detachably attached to the transmitter 200 by the interface 240. Examples of the memory card 200a include memory sticks, media cards, flash memory cards, or smart media.

A common program may be installed in the transmitter 200 and the receiver 300. The common program may include, for example, the transmitter boot program. The common upgrade program is primarily used to upgrade the common program that is pre-stored in the first storage 230. That is, the common upgrade program is a new version of the pre-stored common program of the transmitter 200 and the receiver 300.

The transmitter side upgrade program upgrades the transmitter side program used in the transmitter 200. Similarly, the receiver side upgrade program upgrades a receiver side program used in the receiver 300.

The user input unit 250 is a user interface to output to the first CPU 260 a signal to request a function that is supported by the transmitter 200. To this end, the user input unit 250 includes a plurality of operation keys including number keys, direction keys, and an OK key.

When the memory card 200a is mounted on the interface 240, the user input unit 250 outputs to the first CPU 260 a program upgrade request signal to upgrade the common program and the transmitter side program that are pre-stored in the first storage 230.

The first CPU 260 controls the overall operation of the transmitter 200 according to the transmitter control program stored in the first storage 230 and an operation of the user input unit 250. Accordingly, the first CPU 260 controls the encoder 210 and the first wireless communication unit 220 to encode the input audio and video signals and transmit the encoded audio and video signals to the receiver 300.

In particular, the first CPU 260 downloads, when the memory card 200a is mounted on the interface 240, the common upgrade program and the transmitter side upgrade program from the memory card 200a onto the first storage 230, in order to upgrade the common program and the transmitter side program that are pre-stored in the first storage 230.

In effect, the first CPU 260 automatically downloads the common upgrade program and the transmitter side upgrade program as soon as the memory card 200a is mounted. Moreover, when the program upgrade request signal is received from the user input unit 250 after the memory card 200a is mounted, the first CPU 260 is allowed to download the common upgrade program and the transmitter side upgrade program from the memory card 200a.

The first CPU 260 checks the version of each program before downloading the common upgrade program and the transmitter side upgrade program from the memory card 200a. In other words, the first CPU 260 downloads the common upgrade program and the transmitter side upgrade program from the memory card 200a when they are later versions of the common program and the transmitter side program that are pre-stored in the first storage 230.

When the pre-stored common program and the pre-stored transmitter side program are upgraded by the common upgrade program and the transmitter side upgrade program, respectively, the first CPU 260 controls the first wireless communication unit 220 to transmit to the receiver 300 the common upgrade program and the receiver side upgrade program stored in the memory card 200a. The common upgrade program and the receiver side upgrade program are transmitted from the transmitter 200 to the receiver 300 over the wireless channel.

The receiver 300 upgrades the common program and the receiver side program that are pre-stored therein with the common upgrade program and the receiver side upgrade program that are transmitted over the wireless channel.

To this end, the receiver 300 includes a second wireless communication unit 310, a decoder 320, a buffer 330, a second storage 340, and a second CPU 350.

The second wireless communication unit 310 receives the audio and video signals from the transmitter 200, and provides the received audio and video signals to the decoder 320. Also, the second wireless communication unit 310 receives the common upgrade program and the receiver side upgrade program from the transmitter 200, and provides the received common upgrade and receiver side upgrade programs to the buffer 330.

The decoder 320 decodes the audio and video signals provided from the second wireless communication unit 310 in the MPEG format.

The buffer 330 temporarily stores the common upgrade program and the receiver side upgrade program that are input from the second wireless communication unit 310.

The second storage 340 stores a receiver control program to control and manage the overall operation of the receiver 300, a receiver boot program to boot the receiver 300, and the receiver side program to execute diverse functions of the receiver 300. The receiver side program is a predetermined receiver application program. The boot program and the receiver side program are pre-stored in the second storage 340 and may be upgraded to new versions.

The second CPU 350 controls the overall operation of the receiver 300 on the basis of the receiver control program stored in the second storage 340. Accordingly, the second CPU 350 controls the second wireless communication unit 310 and the decoder 320 to decode the input audio and video signals from the second wireless communication unit 310.

The second CPU 350 also controls the second wireless communication unit 310 to provide the buffer 330 with the common upgrade program and the receiver side upgrade program, and checks the versions of the common upgrade program and the receiver side upgrade program that are temporarily stored in the buffer 330, the pre-stored common program and the pre-stored receiver side program. If the common upgrade and receiver side upgrade programs in the buffer 330 are new versions, the second CPU 350 downloads the common upgrade program and the receiver side upgrade program from the buffer 330 onto the second storage 340, and upgrades the pre-stored common program and the pre-stored receiver side program.

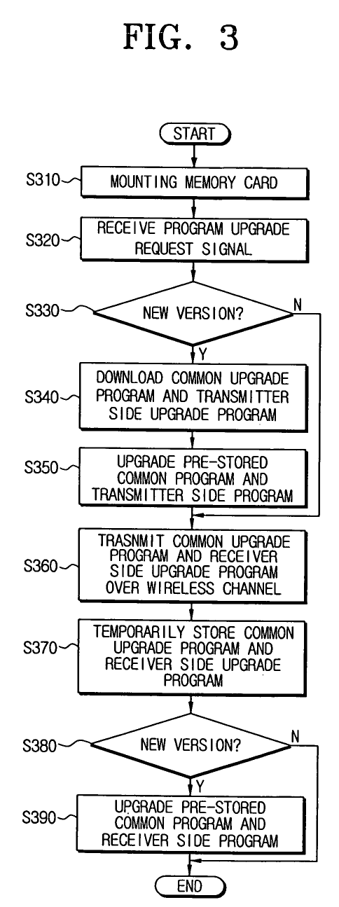

FIG. 3 is a flowchart of a method of upgrading programs in the wireless communication system 100 of FIG. 1.

Referring to FIG. 1 through FIG. 3, when the program upgrade request signal is received from the user input unit 250 after the memory card 200a is mounted on the interface 240, the first CPU 260 checks if the common upgrade program and the transmitter side upgrade program in the memory card 200a are new versions (S310, S320, S330).

More specifically, if the common upgrade program and the transmitter side upgrade program stored in the memory card 200a are later versions than the pre-stored common program and the pre-stored transmitter side program, respectively, stored in the first storage 230, the first CPU 260 determines that the versions of the common upgrade and transmitter side upgrade programs in the memory card 200a are new, compared with the pre-stored common and transmitter side programs in the first storage 230.

If the common upgrade and transmitter side upgrade programs in the memory card 200a are new versions in operation 330, the first CPU 260 downloads the common upgrade program and the transmitter side upgrade program from the memory card 200a onto the first storage 230 (S340).

The first CPU 260 upgrades the common program and the transmitter side program that are pre-stored in the first storage 230 with the downloaded common upgrade program and transmitter side upgrade program (S350).

Following the upgrade, the first CPU 260 controls the first wireless communication unit 220 to read the common upgrade program and the receiver side upgrade program from the memory card 200a, and transmit the common upgrade and receiver side upgrade programs to the receiver 300 (S360).

The second CPU 350 controls the second wireless communication unit 310 to receive the common upgrade program and the receiver side upgrade program that are transmitted over the wireless channel, and to provide the common upgrade program and the receiver side upgrade program to the buffer 330 (S370). Therefore, the common upgrade program and the receiver side upgrade program are temporarily stored in the buffer 330.

The second CPU 350 checks whether the common upgrade program and the receiver side upgrade program that are temporarily stored in the buffer 330 are new versions (S380). If the temporarily stored common upgrade program and the temporarily stored receiver side upgrade program are new versions, the second CPU 350 downloads the temporarily stored common upgrade program and the temporarily stored receiver side upgrade program from the buffer 330 onto the second storage 340, and upgrades the pre-stored common program and the pre-stored receiver side program (S390).

The memory card 200a may be mounted on one of the transmitter 200 (that is, the set-top box) and the receiver 300 (that is, the digital TV) and may upgrade the pre-stored common and transmitter side programs installed in the transmitter 200 and the pre-stored common and receiver side programs installed in the receiver 300. In other words, unlike a conventional wireless communication system using two separate memory cards (not shown) to upgrade the programs of the transmitter and the receiver, the wireless communication system of the present general inventive concept uses only one memory card 200a to upgrade the pre-stored common and transmitter side programs of the transmitter 200 and the pre-stored common and receiver side programs of the receiver 300.

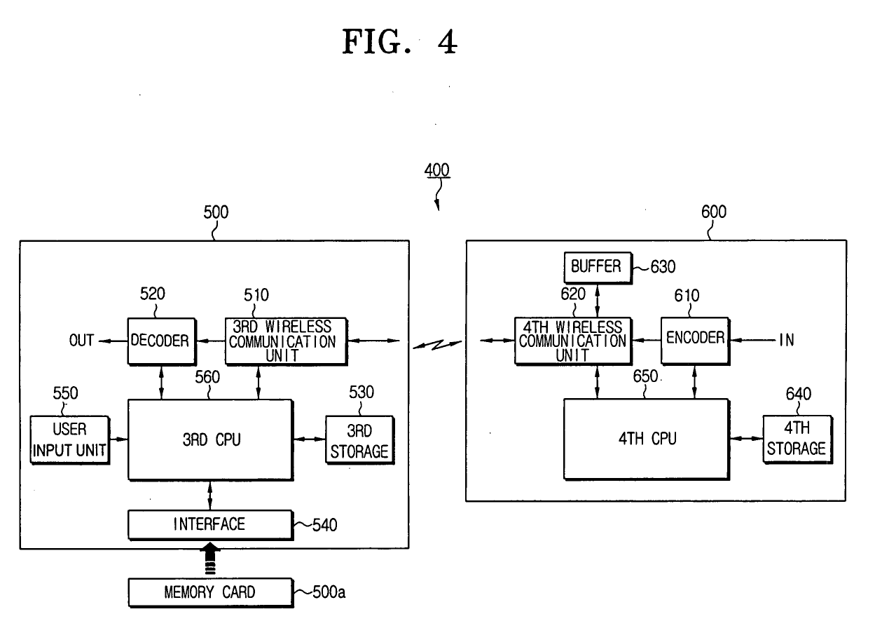

FIG. 4 is a schematic block diagram of a wireless communication system 400 having a program upgrade function according to another embodiment of the present general inventive concept.

As shown in FIG. 4, the wireless communication system 400 includes a memory card 500a, a transmitter 500 and a receiver 600. Since the operations of the memory card 500a, the transmitter 500 and the receiver 600 of FIG. 4 are quite similar to the memory card 200a, the transmitter 200, and the receiver 300 in FIG. 1 through FIG. 3, descriptions about the operations thereof will be omitted. Referring to FIGS. 1 through 4, the receiver 600 may be the set-top box, encoding input audio and video signals from the image source and transmitting the encoded signals to the transmitter 500. The transmitter 500 may be the digital TV, reproducing the audio and video signals transmitted from the receiver 600.

After attaching the memory card 500a to the transmitter 500, the transmitter 500 downloads a common upgrade program and a transmitter side upgrade program from the memory card 500a, and transmits the common upgrade and receiver side upgrade programs to the receiver 600. To this end, the transmitter 500 includes a third wireless communication unit 510, a decoder 520, a third storage 530, an interface 540, a user input unit 550, and a third CPU 560.

The third wireless communication unit 510 receives the audio and video signals that are transmitted from the receiver 600, and provides the programs to the decoder 520.

The decoder 520 decodes the received audio and video signals provided from the third wireless communication unit 510 in the MPEG format.

The third storage 530 stores a transmitter control program, a transmitter boot program to boot the transmitter 500, and a transmitter side program to execute predetermined functions. The transmitter boot program and the transmitter side program are pre-stored in the third storage 530 and may be upgraded to new versions. The common upgrade program may upgrade the pre-stored common program stored in third storage 530.

The interface 540 is mounted with the memory card 500a, and connects the memory card 500a and the third CPU 560. The memory card 500a is similar to the memory card 200a as shown in FIG. 2, and is a storage medium to store the common upgrade program, the transmitter side upgrade program, and the receiver side upgrade program. The memory card 500a may be detachably attached to the transmitter 500 by the interface 540.

When the memory card 500a is mounted on the interface 540, the user input unit 550 outputs to the third CPU 560 a program upgrade request signal to upgrade the common program and the transmitter side program that are pre-stored in the third storage 530.

The third CPU 560 controls the overall operation of the transmitter 500, on the basis of the transmitter control program stored in the third storage 530. Accordingly, the third CPU 560 controls the third wireless communication unit 510 and the decoder 520 to receive and decode the audio and video signals transmitted from the receiver 600.

In particular, the third CPU 560 downloads, when the memory card 500a is mounted on the interface 540, the common upgrade program and the transmitter side upgrade program from the memory card 500a onto the third storage 530, in order to upgrade the common program and the transmitter side program that are pre-stored in the third storage 530.

Following the upgrade, the third CPU 560 controls the third wireless communication unit 510 to transmit the common upgrade program and the receiver side upgrade program stored in the memory card 500a to the receiver 600. The common upgrade program and the receiver side upgrade program are transmitted to the receiver 600 over a wireless channel.

The receiver 600 upgrades the common program and the receiver side program that are pre-stored therein with the common upgrade program and the receiver side upgrade program that are transmitted from the transmitter 500 over the wireless channel. To this end, the receiver 600 includes an encoder 610, a fourth wireless communication unit 620, a buffer 630, a fourth storage 640, and a fourth CPU 650.

The encoder 610 encodes the input audio and video signals in the MPEG format.

The fourth wireless communication unit 620 transmits the input audio and video signals from the encoder 610 to the transmitter 500 over the wireless channel. Also, the fourth wireless communication unit 620 receives the common upgrade program and the receiver side upgrade program from the transmitter 500, and provides the common upgrade and receiver side upgrade programs to the buffer 630.

The buffer 630 temporarily stores the common upgrade program and the receiver side upgrade program that are input from the fourth wireless communication unit 620.

The fourth storage 640 stores a receiver control program, a receiver boot program to boot the receiver 600, and a receiver side program to execute diverse functions of the receiver 600. The receiver boot program and the receiver side program are pre-stored in the fourth storage 640 and may be upgraded to new versions. The common upgrade program may upgrade the pre-stored common program stored in the fourth storage 640.

The fourth CPU 650 controls the overall operation of the receiver 600 on the basis of the receiver control program stored in the fourth storage 640. Accordingly, the fourth CPU 650 controls the fourth wireless communication unit 620 to provide the buffer 630 with the common upgrade program and the receiver side upgrade program received from the transmitter 500.

If the common upgrade program and the receiver side upgrade program that are temporarily stored in the buffer 630 are later versions than the common program and the receiver side program that are pre-stored in the fourth storage 640, the fourth CPU 650 downloads the common upgrade program and the receiver side upgrade program from the buffer 630 onto the fourth storage 640, thereby upgrading the pre-stored common program and the pre-stored receiver side program with the downloaded common upgrade program and receiver side upgrade program, respectively.

As described above, the memory card 500a is mounted on only the transmitter 500 (that is, a digital TV), and upgrades the pre-stored common and transmitter side programs installed in the transmitter 500 and the pre-stored common receiver side programs installed in receiver 600.

Moreover, the transmitters 200 and 500 of the wireless communication systems 100 and 400 according to the various embodiments of the present general inventive concept are capable of downloading upgrade programs not only from the memory cards 200a and 500a, but also from a computer (not shown) where the common upgrade program and the transmitter and receiver side upgrade programs are stored. In this embodiment, the transmitter 200 or 500 is connected to the computer by a communication unit, for example, a serial interface, a parallel communication, a universal serial bus (USB) communication a local area network (LAN) communication, an Internet communication, or a wireless communication, to communicate with the computer to receive the common upgrade program and the transmitter and receiver side upgrade programs. Since the computer stores the common upgrade program and the transmitter and receiver upgrade programs, the computer is used as the memory card 200a or 500a.

As described above, the wireless communication system having the program upgrade function and the method of upgrading the program thereof can upgrade programs in the transmitter and the receiver of the wireless communication system by employing only a single memory card storing the common upgrade program, the transmitter side upgrade program, and the receiver side upgrade program.

The use of one memory card consequently reduces the manufacturing cost because the single memory card can be used to upgrade both a transmitter and a receiver.

The commonly used programs in the transmitter and the receiver can be upgraded using the memory card. Thus, it is possible to reduce the capacity of the entire program stored in the memory card.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A wireless communication system having a program upgrade function, the system comprising:
a transmitter to download a common upgrade program, a transmitter side upgrade program and a receiver side upgrade program from a memory card and to transmit the common upgrade program and the receiver side program over a wireless channel; and
a receiver to receive and store the common upgrade program and the receiver side upgrade program that are transmitted over the wireless channel.

2. The system according to claim 1, wherein the common upgrade program upgrades existing common programs pre-stored in the transmitter and the receiver.

3. The system according to claim 1, wherein the transmitter upgrades an existing common program and an existing transmitter side program with the downloaded common upgrade program and transmitter side upgrade program, respectively.

4. The system according to claim 1, wherein the transmitter comprises:
an interface on which the memory card is mounted;
a first storage to store a predetermined common program and a predetermined transmitter side program;
a first wireless communication unit to transmit the common upgrade program and the receiver side upgrade program to the receiver over the wireless channel; and
a first CPU to download the common upgrade program and the transmitter side upgrade program from the memory card onto the first storage to upgrade the predetermined common program and the predetermined transmitter side program if the memory card is mounted on the interface, and the first CPU to control the first wireless communication unit to transmit the common upgrade program and the receiver side upgrade program stored in the memory card.

5. The system according to claim 4, wherein the first CPU upgrades the predetermined common program and the predetermined transmitter side program, if the common upgrade program and the transmitter side upgrade program stored in the memory card are later versions than the predetermined common program and the predetermined transmitter side program.

6. The system according to claim 1, wherein the receiver comprises:
a second wireless communication unit to receive the common upgrade program and the receiver side upgrade program from the transmitter over the wireless channel;
a second storage to store a predetermined common program and a predetermined receiver side program; and
a second CPU to download the common upgrade program and the receiver side upgrade program that are received through the second wireless communication unit onto the second storage, and to upgrade the predetermined common program and the predetermined receiver side program.

7. The system according to claim 6, wherein the receiver comprises:
a buffer to temporarily store the received common upgrade program and the received receiver side upgrade program.

8. The system according to claim 7, wherein the second CPU upgrades the predetermined common program and the predetermined receiver side program, if the temporarily stored common upgrade program and the temporarily stored receiver side program are later versions than the predetermined common program and the predetermined receiver side program.

9. The system according to claim 1, wherein the transmitter is a set-top box to receive and process audio and video signals from an image source, and the receiver is a TV to reproduce the audio and video signals received from the transmitter.

10. The system according to claim 1, wherein the transmitter is a TV to reproduce audio and video signals emitted from the receiver, and the receiver is a set-top box to receive and process the audio and video signals from an image source.

11. A method of upgrading programs in a wireless communication system, the method comprising:
downloading from a memory card a common upgrade program, a transmitter side upgrade program and a receiver side upgrade program;
transmitting the common upgrade program and the receiver side program over a wireless channel to a receiver; and
receiving and storing the common upgrade program and the receiver side upgrade program that are transmitted over the wireless channel.

12. The method according to claim 11, wherein the transmitting of the common upgrade program and the receiver side program comprises:
mounting the memory card on a transmitter;
downloading the common upgrade program and the transmitter side upgrade program from the memory card, and upgrading a predetermined common program and a predetermined transmitter side program, with the common upgrade program and the transmitter side upgrade program; and
transmitting the common upgrade program and the receiver side upgrade program stored in the memory card to the receiver over the wireless channel.

13. The method according to claim 12, wherein mounting of the memory card on the transmitter comprises:
generating a program upgrade request to upgrade the predetermined common program and the predetermined transmitter side program.

14. The method according to claim 12, wherein mounting of the memory card on the transmitter comprises:
automatically downloading the common upgrade program and the transmitter side upgrade program to upgrade the predetermined common program and the predetermined transmitter side program.

15. The method according to claim 12, wherein downloading of the common upgrade program and the transmitter side upgrade program comprises:
checking the version of the common upgrade program, the transmitter side upgrade program, the predetermined common program and the predetermined transmitter side upgrade program;
determining whether the common upgrade program and transmitter side upgrade program are later versions than the predetermined common program and the predetermined transmitter side program; and
upgrading the predetermined common program and the predetermined transmitter side program when the common upgrade program and transmitter side upgrade program are later versions than the predetermined common program and the predetermined transmitter side program.

16. The method according to claim 11, wherein the receiving of the common upgrade program and the receiver side upgrade program comprises:
receiving the common upgrade program and the receiver side upgrade program that are transmitted over the wireless channel; and
upgrading a predetermined common program and a predetermined receiver side program with the received common upgrade program and the received receiver side upgrade program.

17. The method according to claim 11, wherein upgrading of the predetermined common program and the predetermined receiver side program with the received common upgrade program and received receiver side upgrade program comprises:
checking the version of the common upgrade program, the receiver side upgrade program, the predetermined common program and the predetermined receiver side upgrade program;
determining whether the common upgrade program and receiver side upgrade program are later versions than the predetermined common program and the predetermined receiver side program; and
upgrading the predetermined common program and the predetermined receiver side program when the common upgrade program and receiver side upgrade program are later versions than the predetermined common program and the predetermined receiver side program.

18. The method according to claim 11, wherein:
the transmitting of the common upgrade program and the receiver side upgrade program comprises executing the transmitting of the common upgrade program and the receiver side upgrade program in a set-top box to receive and process audio and video signals from an image source; and
the receiving of the common upgrade program and the receiver side upgrade program comprises executing the receiving of the common upgrade program and the receiver side upgrade program in a TV to reproduce the audio and video signals received from a transmitter.

19. The method according to claim 11, wherein:
the transmitting of the common upgrade program and the receiver side upgrade program comprises executing the transmitting of the common upgrade program and the receiver side upgrade program in a TV to reproduce audio and video signals received from a receiver; and
the receiving of the common upgrade program and the receiver side upgrade program comprises executing the receiving of the common upgrade program and the receiver side upgrade program in a set-top box to receive and process the audio and video signals from an image source and outputting the audio and video signals to the TV.

20. A wireless communication system having a program upgrade function, comprising:
a transmitter to download a common upgrade program, a transmitter side upgrade program, and a receiver side upgrade program from a storage medium, to upgrade an existing common program with the downloaded common upgrade program, to upgrade an existing transmitter side upgrade program with the downloaded transmitter side upgrade program, and to transmit the downloaded common upgrade program and the receiver side upgrade program to an external receiver.

21. The system according to claim 20, wherein the transmitter transmits the common upgrade program and the receiver side upgrade program to the external receiver through a wireless channel.

22. The system according to claim 21, wherein the transmitter transmits audio and video signals to the external receiver through the wireless channel.

23. The system according to claim 20, wherein the transmitter communicates with the external receiver through a wireless channel to transmit the common upgrade program, the receiver side upgrade program, and audio and video signals.

24. The system according to claim 23, wherein the external receiver upgrades an existing common program and an existing receiver side program with the received common upgrade program and the received receiver side upgrade program, respectively.

25. The system according to claim 24, wherein the external receiver generates a display signal corresponding to the received video signal.

26. The system according to claim 20, wherein the external receiver upgrades an existing common program and an existing receiver side program with the received common upgrade program and received receiver side program, respectively.

27. The system according to claim 20, wherein the external receiver comprises one of a set-top box and a TV, and the transmitter comprises the other one of the set-top box and the TV.

28. The system according to claim 20, wherein the storage medium is detachably attached to the transmitter.

29. The system according to claim 20, wherein the storage medium comprises one of a memory card and a computer.

30. The system according to claim 20, wherein the storage medium is a single monolithic medium.

31. A method of upgrading programs in a wireless communication system, the method comprising:
downloading a common upgrade program, a transmitter side upgrade program, and a receiver side upgrade program from a storage medium in a transmitter;
upgrading an existing common program and an existing transmitter side program with the downloaded common upgrade program and the downloaded transmitter side upgrade program, respectively, in a transmitter; and
transmitting the downloaded common upgrade program and the downloaded receiver side program to an external receiver.

32. A wireless communication system having a program upgrade function, comprising:
a transmitter to download a transmitter side upgrade program and a receiver side upgrade program from a storage medium to upgrade an existing transmitter side program with the downloaded transmitter side upgrade program, and to transmit the downloaded receiver side upgrade program to an external receiver.

33. The system according to claim 32, wherein the transmitter transmits audio and video signals and the receiver side upgrade program to the external receiver through a wireless channel.

34. The system according to claim 33, wherein the audio and video signals are decoded in the external receiver, and an existing receiver side program stored in the external receiver is updated with the receiver side upgrade program.

35. The system according to claim 32, wherein the transmitter downloads a common upgrade program from the storage medium, upgrades an existing common program with the downloaded common upgrade program, and transmits the downloaded common upgrade program to the external receiver.

36. A wireless communication system having a program upgrade function, comprising:
a transmitter to download a transmitter side upgrade program and a receiver side upgrade program from the single storage medium, to communicate with an external receiver through a wireless communication channel, to store an existing transmitter side program therein, to upgrade the existing transmitter side program with the downloaded transmitter side upgrade program, and to transmit the downloaded receiver side upgrade program to the external receiver through the wireless communication channel so that an existing receiver side program of the external receiver is updated with the downloaded receiver side upgrade program.

37. The system according to claim 36, wherein the transmitter does not use the downloaded receiver side upgrade program to upgrade the existing transmitter side program of the transmitter.
